(19) United States
(12) Patent Application Publication
(10) Pub. No.: US 2002/0087395 A1
(43) Pub. Date: Jul. 4, 2002

(54) Prepaid parking systems and methods

(76) Inventor: Robert C. Goodman JR., Virginia Beach, VA (US)

Correspondence Address: KAUFMAN & CANOLES, ATTN: PETER A. SHADDOCK II, ONE COMMERCIAL PLACE, P.O. BOX 3037, NORFOLK, VA, 23514, US

(21) Appl. No.: 09/753,289

(22) Filed: Jan. 2, 2001

(51) Int. Cl. G06F 17/60

(52) U.S. Cl. 705/13

(57) ABSTRACT

Prepaid parking systems and methods that allow a user to purchase a prepaid parking pass for a particular event. Once the prepaid parking pass is obtained, a holder is able to present the prepaid parking pass at an entrance to a prepaid parking facility for the particular event. This invention contemplates the availability, at a location proximate to an entrance to the prepaid parking facility, of machines of the type adapted to identify and verify the indicia imprinted on or contained within the prepaid parking pass. When a particular prepaid parking pass, including a particular indicia, is presented, the indicia is identified. Then, verification of the validity of the prepaid parking pass is automatically provided by, for example, a database containing valid prepaid parking pass indicia data. If the prepaid parking pass is determined to be valid, the vehicle is allowed to enter the parking facility. If, on the other hand, the prepaid parking pass is determined to be invalid, the vehicle is not allowed to enter the parking facility.

### BACKGROUND OF THE INVENTION

1. Field of the Invention This invention relates to prepaid parking.

2. Description of Related Art

Generally, it is known that parking areas and/or garages utilized for professional sporting events, theme or amusement parks, concerts, airports, bus stations, train stations, trade shows, and the like, can become extremely crowded and cause congestion and traffic control problems, especially just before a well attended event. This can lead not only to congestion and traffic control problems within the parking facility itself, but also to traffic control problems on streets and highways near and around the parking facility.

Usually, a fee is charged for using the parking facility and the process of collecting parking tolls from entering vehicles is quite time consuming. Thus, as tolls are being collected, traffic congestion is increased and the normal flow of traffic is interrupted. In an attempt to alleviate congestion in and around a given parking facility, a substantial number of personnel are typically employed to direct traffic and collect tolls as vehicles enter the parking facility.

Nevertheless, the inconvenience to those entering the parking facility as well as to travelers who happen to be caught in the traffic around the parking facility is substantial. Having to wait to enter a parking facility has been known to cause attendees to be late for or even forgo attendance at a particular event.

### SUMMARY OF THE INVENTION

Summarized briefly, the prepaid parking systems and methods of this invention allow a user to purchase a prepaid parking pass for a particular event. Because most events require an attendee to purchase a ticket to the event, in various exemplary embodiments, the prepaid parking pass is purchased contemporaneously with the ticket to the event. Furthermore, because some services allow tickets to be purchased “on line” and printed by the purchaser, the systems and methods of this invention provide a user with the ability to purchase and print a prepaid parking pass along with a ticket purchased “on line”.

The prepaid parking pass may be in the form of, for example, a ticket, pass, card, decal, hang tag, sticker, or the like. In various exemplary embodiments, the prepaid parking pass may include an optically scannable symbol or indicia, such as, for example, a Universal Product Code (UPC) or bar code, or a machine readable indicia imprinted on a surface of the prepaid parking pass. In various exemplary embodiments, the prepaid parking pass may include readable indicia, such as, for example, a magnetic strip, an inductively readable memory, or an energizable circuit, affixed to, contained within, or integrated into the prepaid parking pass. The prepaid parking pass may be presented by the holder or affixed to a window or other suitable location on a vehicle.

Once the prepaid parking pass is obtained, the holder is able to present the prepaid parking pass at an entrance to a prepaid parking facility for the particular event. When presented, an indicia imprinted on or contained within the prepaid parking pass can be identified such that, if the indicia is representative of a valid prepaid parking pass, the holder is able to enter the prepaid parking facility.

Various exemplary embodiments of this invention contemplate the availability, at a location proximate to an entrance to the prepaid parking facility, of machines of the type adapted to identify and verify the indicia imprinted on or contained within the prepaid parking pass. When a particular indicia is identified, verification of the validity of the prepaid parking pass is automatically provided via, for example, a database containing valid prepaid parking pass indicia data. If the prepaid parking pass is determined to be valid, the vehicle is allowed to enter the parking facility. If, on the other hand, the prepaid parking pass is determined to be invalid, the vehicle will not be allowed to enter the parking facility.

This invention separately provides systems and methods that allow a user to prepay for parking at a particular event.

This invention separately provides systems and methods that provide a user with a prepaid parking ticket or pass that includes a prepaid parking pass indicia, which allows the holder to access a parking facility at a particular event.

This invention separately provides systems and methods that allow a user to reactivate an indicia of a previously used prepaid parking pass.

This invention separately provides systems and methods that reduce traffic control problems in and around a parking area for a particular event.

This invention separately provides systems and methods that allow an increased flow of traffic into parking facilities, where traffic typically becomes congested during events for which the parking facility is used.

This invention separately provides systems and methods that reduce or eliminate the requirement that a vehicle stop to pay a toll before entering a parking facility.

This invention separately provides systems and methods that reduce the expense to owners and/or operators of parking facilities by reducing the number of employees or staff necessary to collect tolls for the parking facilities.

This invention separately provides systems and methods that reduce the total amount of cash that must be handled and accounted for by employees or staff of a parking facility.

This invention separately provides systems and methods that allow parking tolls to be transferred to the owners and/or operators of parking facilities.

These and other features and advantages of this invention are described in or are apparent from the following detailed description of the exemplary embodiments, the accompanying drawings, and/or the appended claims.

### BRIEF DESCRIPTION OF THE DRAWINGS

The exemplary embodiments of this invention will be described in detail, with reference to the following figures, wherein like reference numerals refer to like parts throughout the several views, and wherein:

FIG. 1 is a plan view of a first side of a first exemplary embodiment of a multi-part ticket according to this invention;

FIG. 2 is a plan view of a first side of a second exemplary embodiment of a prepaid parking pass according to this invention;

FIG. 3A is a plan view of a first side of a third exemplary embodiment of a prepaid parking pass according to this invention;

FIG. 3B is a plan view of a second side of the prepaid parking pass of this invention, as shown in FIG. 3A;

FIG. 4A is plan view of a first side of a fourth exemplary embodiment of a prepaid parking pass according to this invention;

FIG. 4B is a plan view of a second side of the prepaid parking pass of this invention, as shown in FIG. 4A;

FIG. 5 is a functional block diagram of one exemplary embodiment of a prepaid parking system according to this invention;

FIG. 6 is a flowchart outlining one exemplary embodiment of a (control routine) method for issuing a prepaid parking pass according to this invention;

FIG. 7 is a schematic diagram showing a first exemplary embodiment of a prepaid parking system according to this invention;

FIG. 8 is a schematic diagram showing a second exemplary embodiment of a prepaid parking system according to this invention; and

FIG. 9 is a flowchart outlining one exemplary embodiment of a method for using the prepaid parking systems of this invention.

### DETAILED DESCRIPTION OF THE PREFERRED EMBODIMENTS

For simplicity and clarification, the operating principles, design factors, and layout of the prepaid parking systems and methods according to this invention are explained with reference to various exemplary embodiments of prepaid parking systems and methods according to this invention. The basic explanation of the operation of the prepaid parking systems and methods is applicable for the understanding and design of the constituent components employed in the prepaid parking systems and methods of this invention.

It should be appreciated that the term “parking pass” is for basic explanation and understanding of the prepaid parking systems and methods of this invention. Therefore, the term “parking pass” is not to be construed as limiting the systems or methods of this invention.

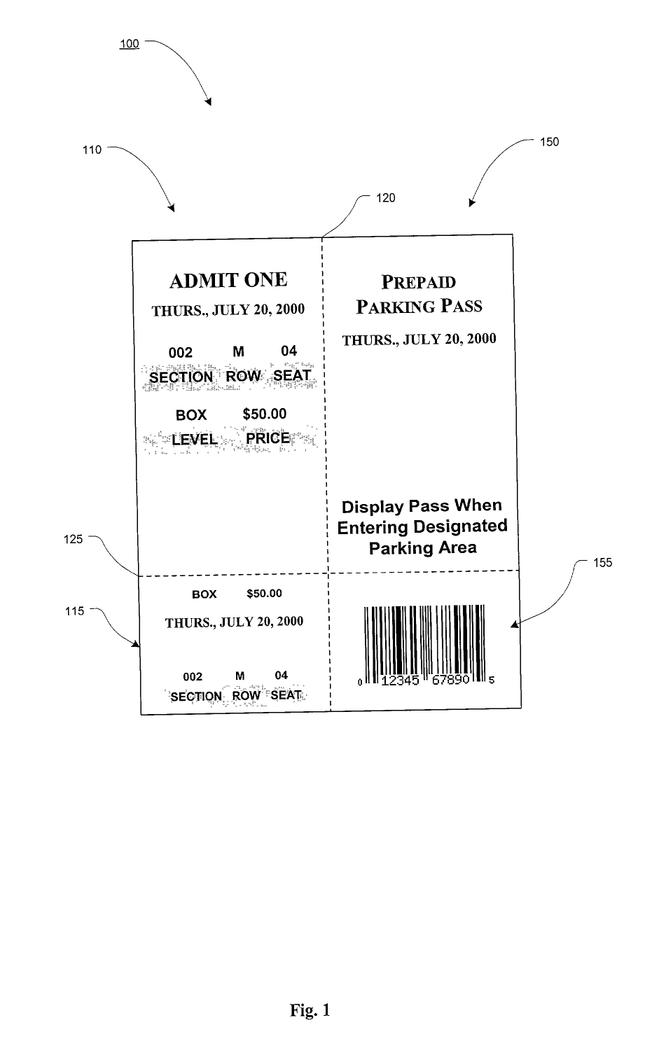

FIG. 1 shows a plain view of a first side of a first exemplary embodiment of a multi-part ticket 100 according to this invention. As shown in FIG. 1, the multi-part ticket 100 includes at least some of an admittance portion 110 and a prepaid parking portion 150.

In various exemplary embodiments, the admittance portion 110 is attached to the prepaid parking portion 150. In various exemplary embodiments, the admittance portion 110 is separably attached to the prepaid parking portion 150, via a perforation line 120. Additionally, the multi-part ticket 100 may also include a perforation line 125. The perforation line 125 allows a portion of the multi-part ticket 100 that includes the parking pass indicia 155 to be separably attached to the multi-part ticket 100. Likewise, a ticket stub 115 may also be separably attached to the multi-part ticket 100.

However, it should be understood that, in various other exemplary embodiments, the prepaid parking portion 150 may be issued separate from the admittance portion 110.

The admittance portion 110 of the multi-part ticket 100 is similar to admittance tickets known to those skilled in the art. Thus, for example, the admittance portion 110 may include information regarding the particular event for which the ticket is issued, and presentation of the admittance portion 110 at the particular event allows the holder to enter the event.

As shown in FIG. 1, the multi-part ticket 100 also includes the prepaid parking portion 150. The prepaid parking portion 150 includes a parking pass indicia 155.

In various exemplary embodiments, the parking pass indicia 155 comprises a Universal Product Code (UPC) or bar code. It should be understood that, in various other exemplary embodiments, the parking pass indicia 155 may be any form of optical or machine readable indicia, such as, for example, a bar code, an optically scannable symbol, an inductively readable indicia, or the like.

During use, the prepaid parking portion 150 may be separated, if necessary, from the admittance portion 110 along the perforation line 120. The prepaid parking portion 150 can then be presented at a prepaid parking entrance of a parking area, to allow the parking pass indicia 155 to be identified.

If, when the parking pass indicia 155 is identified, it is determined that the parking pass indicia 155 represents a valid prepaid parking portion 150, an entry indicator located proximate to the prepaid entrance of the parking area indicates that entry into the parking area, via the prepaid parking entrance, is allowed. In contrast, if it is determined that the parking pass indicia 155 is not representative of a valid prepaid parking portion 150, the entry indicator indicates that entry into the parking area, via the prepaid parking entrance, is not allowed.

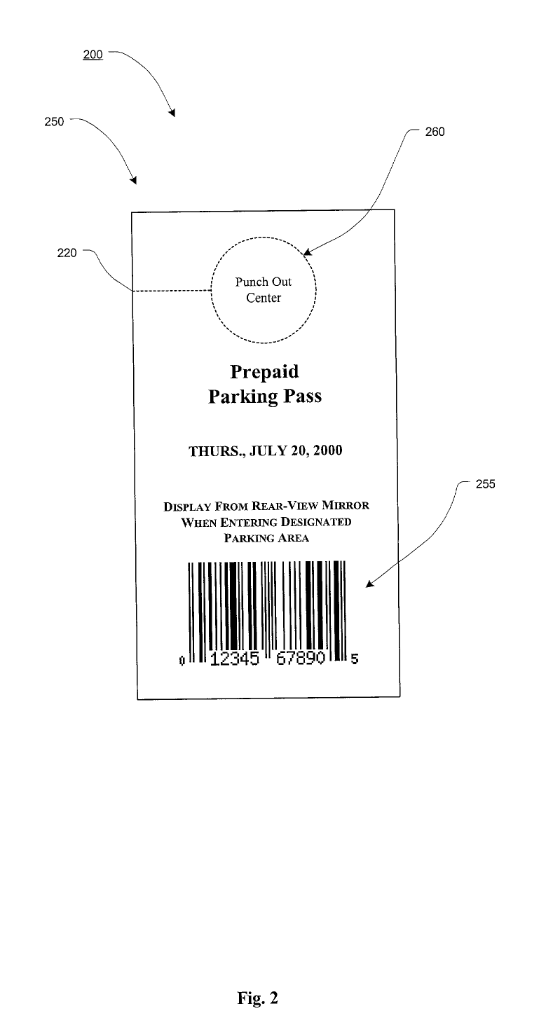

FIG. 2 shows a plain view of a first side of a second exemplary embodiment of a prepaid parking pass 200 according to this invention. As shown in FIG. 2, the prepaid parking pass 200 comprises a prepaid parking portion 250 including a prepaid parking indicia 255. It should be appreciated that the prepaid parking portion 250 may be separably attached to an admittance portion (not shown) of the prepaid parking pass 200, similar to the admittance portion 110 described above, with reference to FIG. 1.

As further shown in FIG. 2, the prepaid parking pass 200 also includes a perforation 220. At least a portion of the perforation 220 defines a removable portion 260. The removable portion 260 allows the prepaid parking portion 250 to be removably attached to, for example, the rear view mirror of a vehicle. In this manner, the prepaid parking pass 200 can be used as a vehicle “hang tag”.

In various exemplary embodiments, the “hang tag” feature of the prepaid parking pass 200 allows the prepaid parking portion 250 to be displayed from the vehicle such that the prepaid parking indicia 255 can be identified.

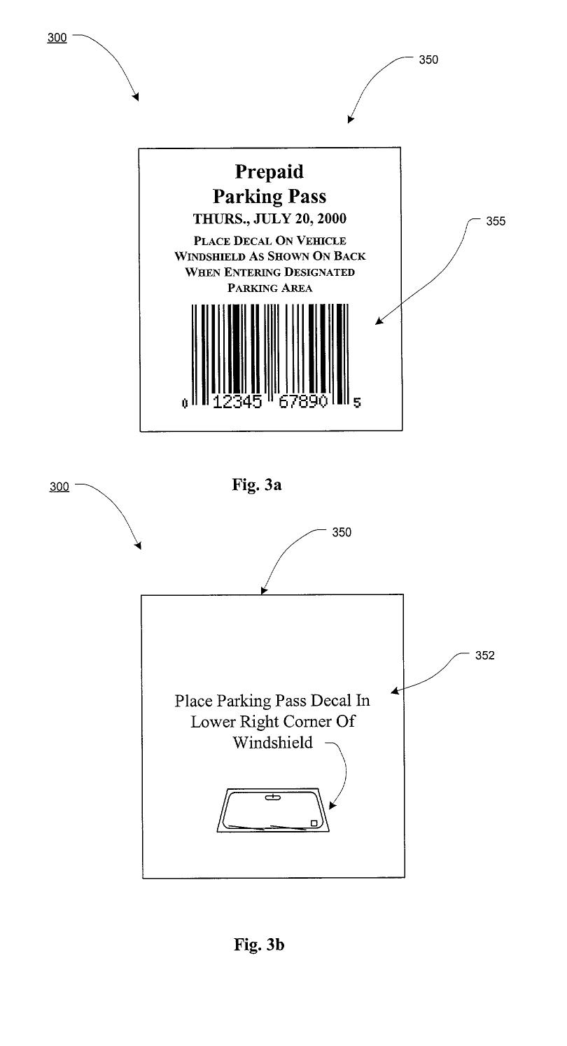

FIGS. 3A and 3B show a first side and a second side, respectively, of a third exemplary embodiment of a prepaid parking pass 300 according to this invention. As shown in FIGS. 3A and 3B, the prepaid parking pass 300 comprises a prepaid parking portion 350 including a prepaid parking indicia 355. This should be appreciated that the prepaid parking portion 350 may be included as part of a multi-part ticket and may be separably attached to an admittance portion (not shown), as described above, with reference to FIG. 1.

In various exemplary embodiments, the prepaid parking portion 350 is a decal that can be affixed to a vehicle prior to the vehicles reaching a prepaid parking entrance of a particular parking area. The decal may be adhesively or statically attached to, for example, the vehicle's windshield.

As shown in FIG. 3B, the second side of the prepaid parking portion 350 may include, for example, a set of prepaid parking instructions 352 that instruct a user in the proper placement of the prepaid parking portion 350 on the vehicle windshield.

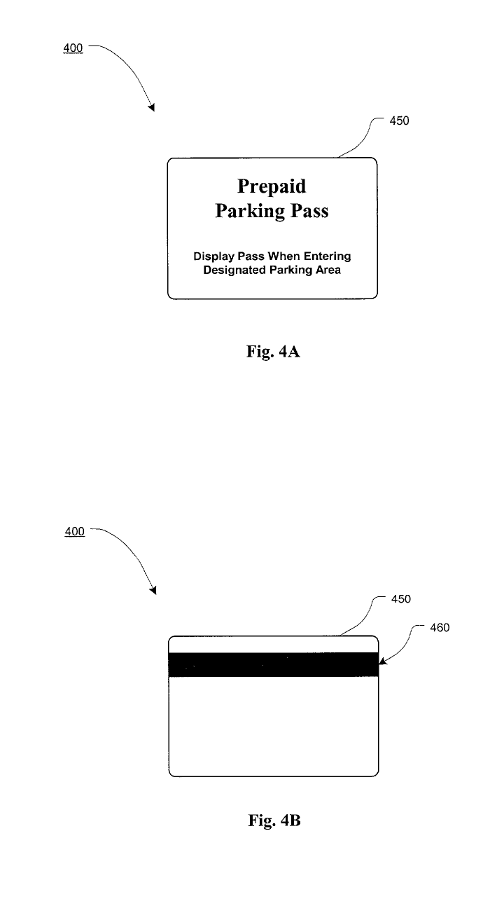

FIGS. 4A and 4B show a first side and a second side, respectively, of a fourth exemplary embodiment of a prepaid parking pass 400 according to this invention. As shown in FIGS. 4A and 4B, the prepaid parking pass 400 comprises a prepaid parking portion 450 including an inductively readable indicia 460. In various exemplary embodiments, the prepaid parking pass 400 is generally the shape and size of an ordinary credit card. However, it should be understood that the prepaid parking portion 450 may be included as part of a multi-part ticket and may be separably attached to an admittance portion (not shown), as described above, with reference to FIG. 1.

The inductively readable indicia 460 allows a parking pass indicia to be inductively integrated into the prepaid parking portion 450. In various exemplary embodiments, the inductively readable indicia 460 comprises a magnetic strip affixed to the prepaid parking portion 450. In various other exemplary embodiments, the inductively readable indicia 460 is, for example, an energizable circuit affixed to or contained within the prepaid parking portion 450.

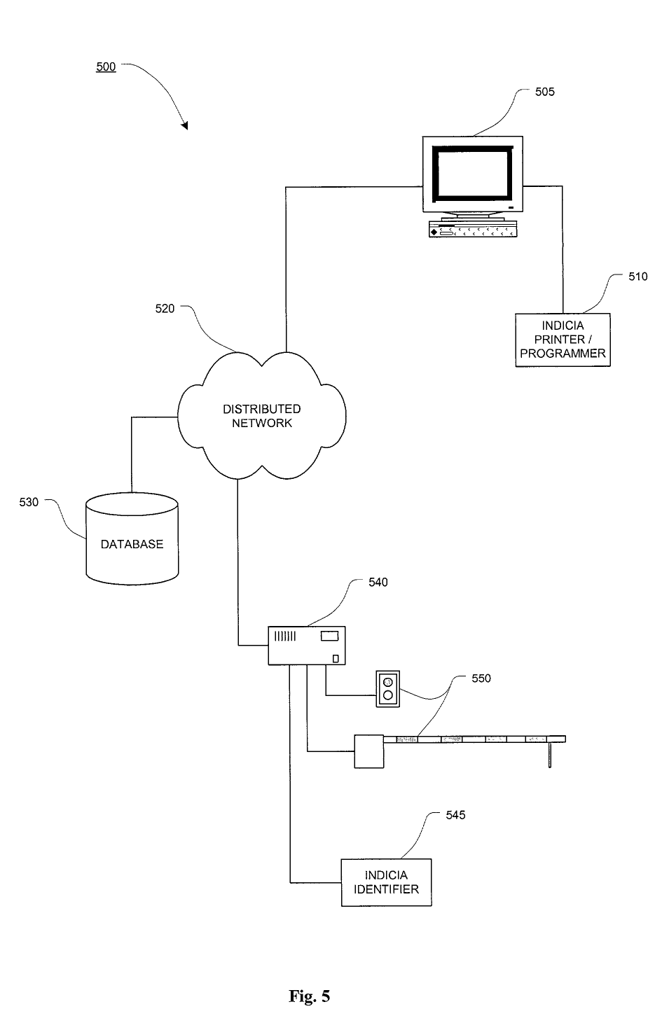

FIG. 5 is a functional block diagram of one exemplary embodiment of a prepaid parking system 500 according to this invention. As shown in FIG. 5, the prepaid parking system 500 includes at least some of a workstation 505, and indicia printer/programmer 510, a database 530, a controller 540, an indicia identifier 545, and a controllable entry indicator 550.

In various exemplary embodiments, the workstation 505 is a personal computer, personal digital assistant (PDA), or the like. Alternatively, the workstation 505 may be, for example, a computer or a terminal connected to a ticket service such as Ticketron® or Ticketmaster®. The workstation 505 allows a user to access the database 530 and receive a valid prepaid parking ticket indicia that permits prepaid access to a parking area. The user can then include the received prepaid parking ticket indicia on a prepaid parking ticket. It should be understood that the received prepaid parking ticket indicia can be included on or contained within any of the prepaid parking passes or tickets described herein.

It should also be understood that the received prepaid parking ticket indicia may be in a form that allows a previously issued or used prepaid parking ticket indicia on a prepaid parking pass or ticket to be reactivated such that the previously issued or used prepaid parking ticket indicia represents a valid prepaid parking ticket indicia.

In various exemplary embodiments, the workstation 505 allows a user to access ticketing and/or parking information via a connection to the database 530 via, for example, a distributed network 520. In various exemplary embodiments, the distributed network 520 is, for example, an intranet, an extranet, the Internet and, more particularly, the Worldwide Web portion of the Internet, a Local Area Network (LAN), a Wide Area Network (WAN), or any other presently known or later developed distributed network.

When a user has accessed the database 530, received a valid prepaid parking ticket indicia, and included the valid prepaid parking ticket indicia on a prepaid parking ticket, the user can present the prepaid parking pass, including valid prepaid parking ticket indicia, to the indicia identifier 545. When the identification means identifies the parking pass indicia, the controller 540 determines whether the indicia is valid. If the controller 540 determines that the indicia is valid, the controller 540 controls the controllable entry indicator 550 to indicate that entry into the prepaid parking area is allowed. It should be understood that in various exemplary embodiments the controllable entry indicator 550 will, for example, illuminate a light or control an entrance barrier to indicate that entrance into the prepaid parking area is allowed.

In various exemplary embodiments, the workstation 505 and/or the controller 540 are/is connected to the database 530 and/or the distributed network 520, via a wired connection. Alternatively, the workstation 505 and/or the controller 540 can interface with the database 530 and/or the distributed network 520 via any linked connection. The linked connection can be any known or later developed device or system for connecting the workstation 505 and/or the controller 540 to the database 530 and/or the distributed network 520 including a direct wired connection, a wireless link, a connection over a local area network (LAN), a wide area network (WAN), or any other distributed network, a connection over the public switched telephone network, a connection over a coaxial cable (i.e., CATV) system, a connection over a cellular telephone network, a very high frequency (VHF) connection, an ultra high frequency (UHF) connection, a radio frequency (RF) connection, a satellite connection, or the like. In general, the linked connection can be any known or later developed connection system or structure suitable to connect the workstation 505 and/or the controller 540 to the database 530 and/or the distributed network 520 including both wired and wireless connections.

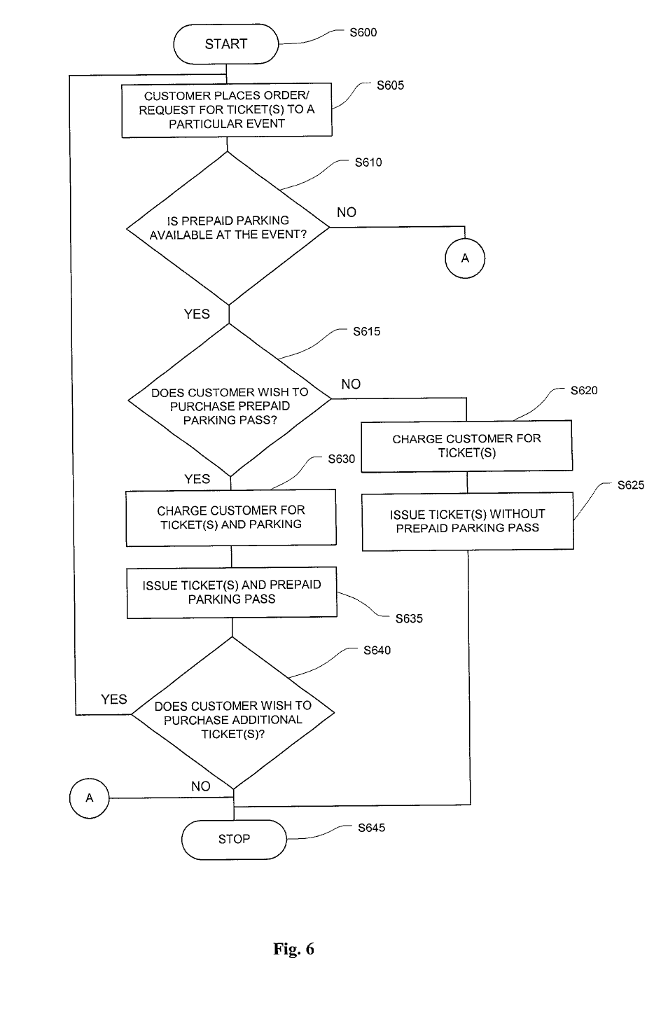

FIG. 6 is a flowchart allowing when exemplary embodiment of a method for using a prepaid parking pass according to this invention.

As shown in FIG. 6, beginning at step S600, control continues to step S605, where a customer places an order or requests at least one ticket to a particular event. Then, in step S610, a determination is made as to whether prepaid parking is available at the particular event.

If, in step S610, it is determined that prepaid parking is not available at the particular event, control jumps to S645. Otherwise, if prepaid parking is available at the particular event, control continues to step S615.

In step S615, a determination is made as to whether the customer wishes to purchase a prepaid parking pass for the particular event. If, in step S615, it is determined that the customer does not wish to purchase a prepaid parking pass for the particular event control continues to step S620.

In step S620, the customer is charged for the price of the ticket(s). Then, in step S625, the ticket(s) is/are issued without a prepaid parking pass. Control then continues to step S645.

If, in step S615, it is determined that the customer wishes to purchase a prepaid parking pass for the particular event, control advances to step S630. In step S630, the customer is charged for the price of the ticket(s) and the prepaid parking. Then, in step S635 the ticket(s) and a prepaid parking pass, including a valid prepaid parking ticket indicia, is issued to the customer. It should be understood that the step of issuing the prepaid parking pass, including a valid prepaid parking ticket indicia, in step S635, may include the step of reactivating or renewing a previously issued prepaid parking ticket indicia. Control then continues to step S640.

In step S640, a determination is made whether the customer wishes to purchase any additional tickets. It should be understood that the additional tickets may be any additional ticket(s) for the same event or for a different event.

If in step S640, it is determined that the customer wishes to purchase at least one additional ticket, control returns to step S605. Otherwise, control continues to step S645 where the method ends.

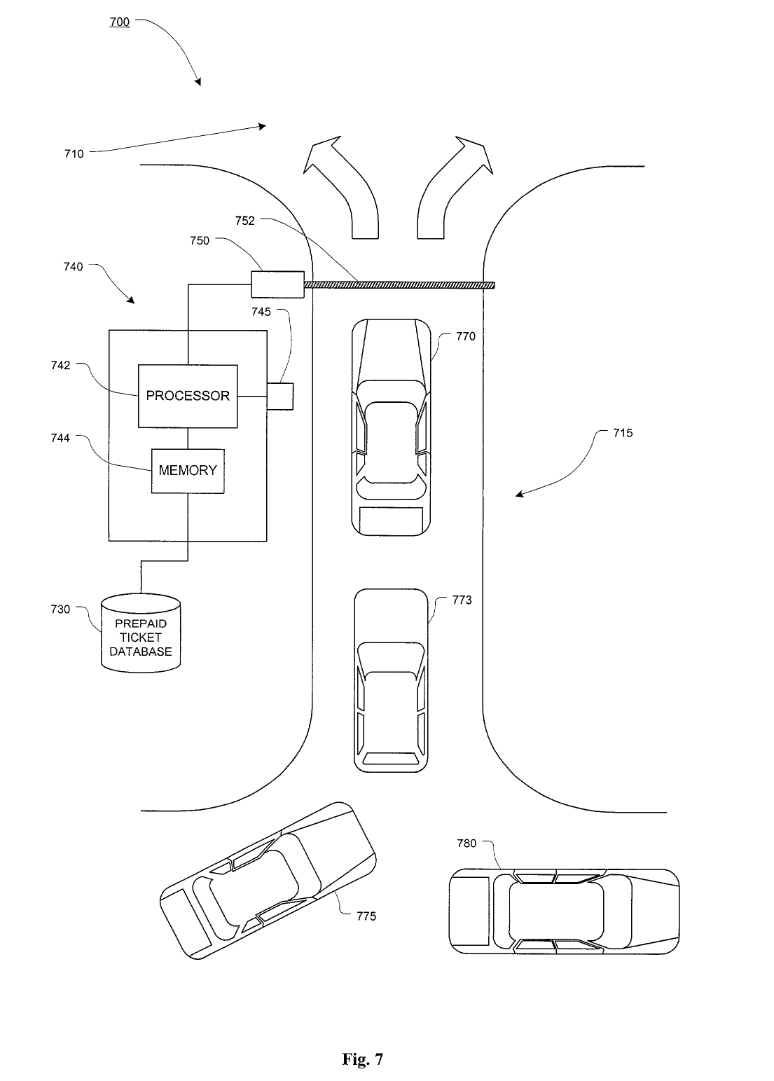

FIG. 7 is a schematic diagram showing a first exemplary embodiment of a prepaid parking system according to this invention. As shown in FIG. 7, the prepaid parking system 700 includes at least some of a prepaid parking area 710, an entrance 715, and a controller 740.

The controller 740 includes at least some of a processor 742, a memory 744, an indicia identifier 745, and a controllable entrance indicator 750. In various exemplary embodiments, the controllable entrance indicator 750 includes, for example, a controllable entrance barrier 752 or an illuminated entry indicator (not shown).

In various exemplary embodiments, the controller 740 is connected to a prepaid ticket database 730. In the various exemplary embodiments described herein, the controller 740 interfaces, for example, with the prepaid ticket database 730, via a wired connection. Alternatively, the controller 740 can interface with the prepaid ticket database 730 via any linked connection. The linked connection can be any known or later developed device or system for connecting the controller 740 to the prepaid ticket database 730 including a direct wired connection, a wireless link, a connection over a local area network (LAN), a wide area network (WAN), or any other distributed network, a connection over the public switched telephone network, a connection over a coaxial cable (i.e., CATV) system, a connection over a cellular telephone network, a very high frequency (VHF) connection, an ultra high frequency (UHF) connection, a radio frequency (RF) connection, a satellite connection, or the like. In general, the linked connection can be any known or later developed connection system or structure suitable to connect the controller 740 to the prepaid ticket database 730 including both wired and wireless connections.

As shown in FIG. 7, the controllable entrance indicator 750 is positioned proximate to the prepaid parking area 710. In various exemplary embodiments, the controllable entrance indicator 750 is placed within an entrance 715 such that incoming vehicles with prepaid parking passes may be diverted from a main traffic area, thereby reducing congestion around the entrance 715 of the prepaid parking area 710.

During operation, the prepaid parking system 700 operates to separate vehicles with prepaid parking passes, such as, for example, vehicle 770, 773, and 775, from vehicles not having prepaid parking passes such as, for example, vehicle 780. As each of the vehicles 770, 773, and 775 approach the indicia identifier 745, a prepaid parking pass can be displayed to the indicia identifier 745.

As the indicia identifier 745 identifies a specific parking pass indicia, the processor 742 determines whether the parking pass indicia represents a valid parking pass. In various exemplary embodiments, the processor 742 accesses, for example, the memory 744 and/or the prepaid ticket database 730 to determine whether the parking pass indicia represents a valid parking pass.

In various exemplary embodiments, the processor 742 accesses the memory 744 and/or the prepaid ticket database 730 via a direct wired connection. However, it should be appreciated that the processor 742 may alternatively interface with the memory 744 and/or the prepaid ticket database 730 through any linked connection, as described above.

If the controller 740 determines that the parking pass indicia represents a valid parking pass, the processor 742 of the controller 740 controls the controllable entrance indicator 750 to indicate that entrance into the prepaid parking area 710 is allowed. For example, in various exemplary embodiments, the controllable entrance indicator 750 may remove the controllable entrance barrier 752 or illuminate a light (now shown) to indicate that entrance into the prepaid parking area 710 is allowed.

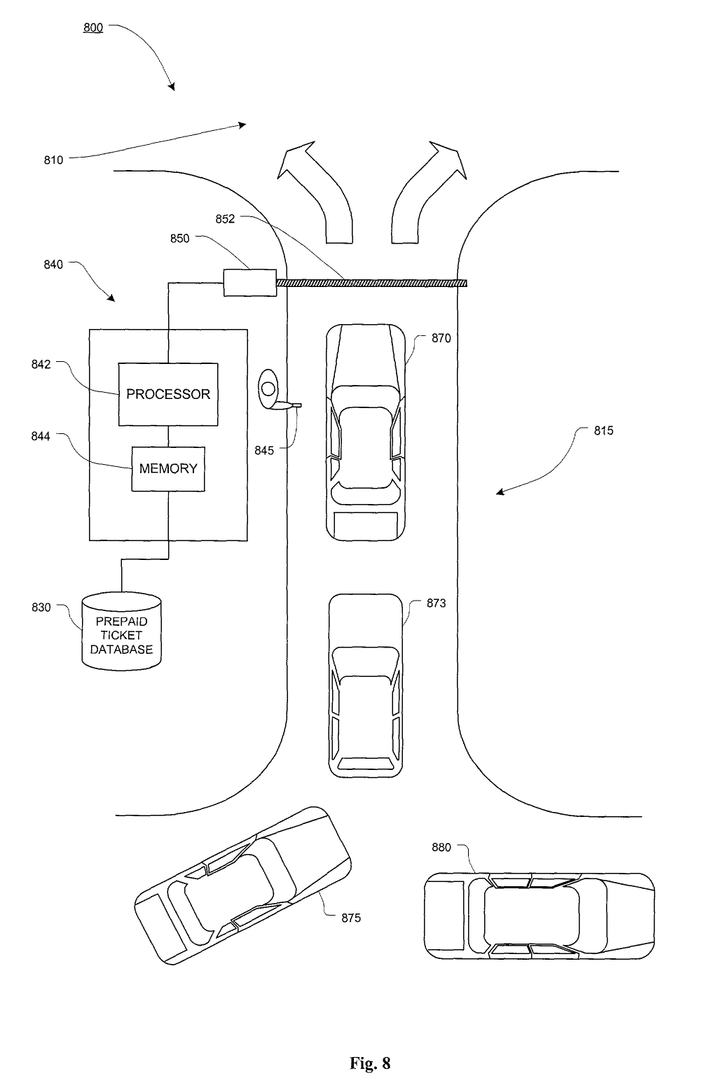

FIG. 8 is a schematic diagram showing a second exemplary embodiment of a prepaid parking system 800 according to this invention. As shown in FIG. 8, the prepaid parking system 800 includes at least some of a prepaid parking area 810, and entrance 815, and a controller 840.

The prepaid parking area 810, the entrance 815, and the controller 840 correspond to and operate similarly to the same elements discussed above to FIG. 7. Furthermore, the prepaid parking system 800 shown in FIG. 8 operates similarly to the prepaid parking system 700 described above with respect to FIG. 7.

However, as shown in FIG. 8, the indicia identifier 845 is a portable indicia identifier. Thus, as shown in FIG. 8, the indicia identifier 845 can be used by an operator to identify a parking pass indicia.

In the various exemplary embodiments described herein, the indicia identifier 845 interfaces, for example with the processor 842, via a wired link. Alternatively, the indicia identifier 845 can interface with the processor 842 via any linked connection. The linked connection can be any known or later developed device or system for connecting the indicia identifier 845 to the processor 842, including a direct wired connection, a wireless link, a connection over a local area network (LAN), a wide area network (WAN), or any other distributed network, a connection over the public switched telephone network, a connection over a coaxial cable (i.e., CATV) system, a connection over a cellular telephone network, a very high frequency (VHF) connection, an ultra high frequency (UHF) connection, a radio frequency (RF) connection, a satellite connection, or the like. In general, the linked connection can be any known or later developed connection system or structure suitable to connect the indicia identifier 845 to the processor 842, including both wired and wireless connections.

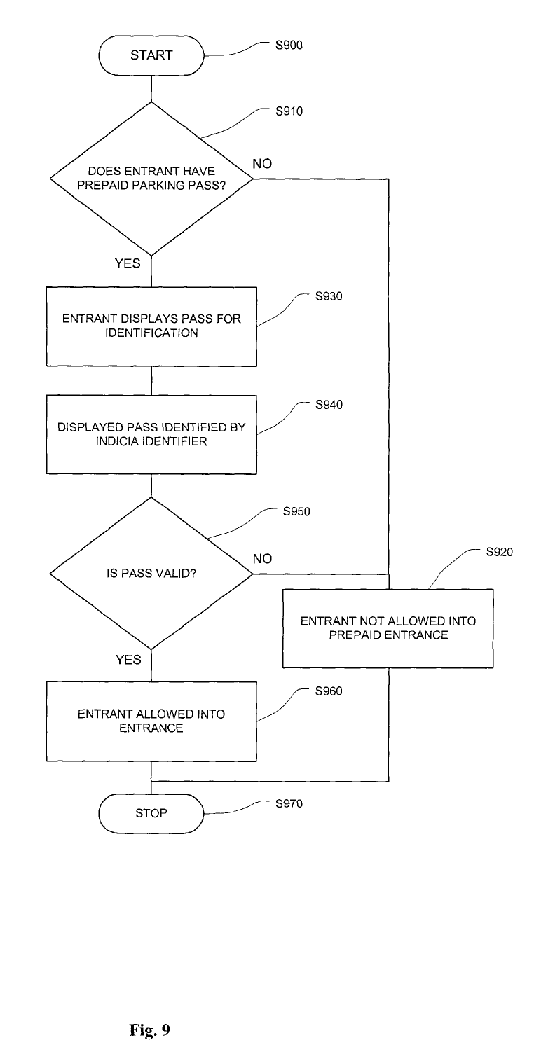

FIG. 9 is a flowchart outlining one exemplary embodiment of a method for using the prepaid parking systems of this invention.

As shown in FIG. 9, beginning at step S900, control continues to step S910 where a determination is made as to whether an approaching, prospective entrant has a prepaid parking pass. If, in step S910 it is determined that the entrant does not have a prepaid parking pass, control advances to step S920.

In step S920, the entrant is not allowed into the prepaid entrance of the prepaid parking area.

If, in step S810, it is determined that the entrant does have a prepaid parking pass, control advances to step S830, where the entrant must display the prepaid parking pass for identification. Then, in step S840, the displayed pass is identified by an indicia identifier. Control then continues to step S850.

In step S850, a determination is made whether the displayed parking pass is valid. If, in step S850, it is determined that the displayed parking pass is not valid, control returns to step S820 and the entrant is not allowed into the prepaid parking entrance of the parking area.

If, it is determined in step S850 that the displayed parking pass is valid, control continues to step S960 and the entrant is allowed into the prepaid entrance of the parking area. Then, in step S870, the method ends.

In various exemplary embodiments, the prepaid parking systems shown in FIGS. 5, 7, and 9, are implemented using a controller 540, 740 and 840, respectively. However, the prepaid parking systems shown in FIGS. 5, 7, and 8 can also be implemented on a suitably programmed general purpose computer, a special purpose computer, a programmed microprocessor or microcontroller and peripheral integrated circuit elements, and/or as physically distinct hardware circuits within an Application-Specific Integrated Circuit (ASIC), or other integrated circuit, a digital signal processor, a hard wired electronic or logic circuit using discrete logic elements or discrete circuit elements, or a discrete element circuit, a programmable logic device using a Field Programmable Gate-Array (FPGA), a Programmable Decision Logic (PDL), a Programmable Logic Array (PLA) or a Programmable Array Logic (PAL), or the like. In general, any device capable of implementing a finite state machine that is in turn capable of implementing the requisite steps of either of the flowcharts shown in FIG. 6 or FIG. 9, can be used to implement the prepaid parking systems show in FIGS. 5, 7, and 8. The particular form that each of the elements of the prepaid parking system(s) will take is a design choice and will be predicable to those skilled in the art.

Moreover, the prepaid parking systems and methods described herein can be implemented as software executing on a programmed general-purpose computer, a special purpose computer, a microprocessor, or the like. In this case, the prepaid parking systems and methods described herein can be implemented as a routine embedded in a driver, as a resource residing on a server, or the like. The prepaid parking systems and methods described herein, can also be implemented by physically incorporating them into a software and/or hardware system.

While this invention has been described in conjunction with the exemplary embodiments outlined above, it is evident that many alternatives, modifications, and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A system for providing prepaid access to a parking area, comprising:
a prepaid ticket having ticket indicia, wherein the prepaid parking ticket was purchased prior to reaching a prepaid parking entrance of the parking area;
a controllable entry indicator located proximate to the prepaid parking entrance of the parking area;
an identification means for identifying the ticket indicia on the prepaid ticket;
a database wherein at least some prepaid ticket indicia data is maintained regarding specific prepaid ticket indicia that has been included on provided prepaid tickets; and
a processor, wherein the processor determines whether the ticket indicia of a given ticket is included in the prepaid ticket indicia data, and controls the controllable entry indicator, such that if the ticket indicia of the given ticket is included in the prepaid ticket indicia data, the controllable entry indicator indicates that entry into the parking area via the prepaid parking entrance is allowed.

2. The prepaid access system of claim 1, wherein the processor amends the prepaid ticket indicia data to show that the ticket indicia of the prepaid parking ticket has been used.

3. The prepaid access system of claim 1, wherein the controllable entry indicator comprises a controllable gate.

4. The prepaid access system of claim 1, wherein the controllable entry indicator comprises at least one light for indicating that entry into the parking area via the prepaid parking entrance is allowed and at least one light for indicating that entry into the parking area via the prepaid parking entrance is denied.

5. The prepaid access system of claim 1, wherein the ticket indicia is a bar code element.

6. The prepaid access system of claim 1, wherein the identification means comprises a bar code reader.

7. The prepaid access system of claim 1, wherein the ticket indicia is included in an inductively readable memory integrated into the prepaid parking ticket.

8. The prepaid access system of claim 1, wherein the identification means comprises a means for inductively identifying the ticket indicia stored in the prepaid parking ticket.

9. The prepaid access system of claim 1, wherein at least a portion of the prepaid parking ticket is adapted to be attached to an exteriorly visible surface of a user's vehicle.

10. The prepaid access system of claim 1, wherein the ticket indicia on the prepaid parking ticket is identified while the user's vehicle is in movement past the identification means.

11. The prepaid access system of claim 1, wherein at least a portion of the prepaid parking ticket comprises a sticker attachable to a surface of a vehicle.

12. The prepaid access system of claim 1, wherein the identification means is located proximate to the controllable entry indicator.

13. The prepaid access system of claim 1, wherein the identification means is a portable identification means.

14. A system for providing prepaid parking for at least one particular event, comprising:
a database including at least some data relating to valid ticket indicia that can be included on a valid prepaid parking ticket;
means for receiving a request for valid ticket indicia that can be included on a valid prepaid parking ticket;
means for providing valid ticket indicia to a valid ticket indicia requester;
means for receiving a request for validation of a ticket indicia included on a presented parking ticket;
means for responding to a request for validation of a ticket indicia, wherein the response indicates whether the ticket indicia included on a presented parking ticket is a valid ticket indicia.

15. The prepaid access system of claim 14, wherein the valid ticket indicia is provided as a bar code element.

16. The prepaid access system of claim 14, wherein the valid ticket indicia is provided in an inductively readable memory integrated into a valid prepaid parking ticket.

17. A method of providing prepaid access to a parking area, the method comprising the steps of:
providing a controllable entry indicator at a location proximate to a prepaid parking entrance of the parking area;
providing an identification means that identifies ticket indicia on a prepaid parking ticket, wherein the prepaid parking ticket was purchased prior to reaching the prepaid parking entrance of the parking area;
accessing a prepaid ticket indicia database, wherein the prepaid ticket indicia database includes at least some prepaid ticket indicia data regarding specific prepaid ticket indicia that has been included on issued prepaid parking tickets;
determining whether the ticket indicia of the prepaid parking ticket is included in the prepaid ticket indicia data; and
controlling the controllable entry indicator such that, if the ticket indicia of the prepaid parking ticket is not included in the prepaid ticket indicia data, the entry indicator indicates that entry into the parking area via the prepaid parking entrance is denied, and if the ticket indicia of the prepaid parking ticket is included in the prepaid ticket indicia data, the entry indicator indicates that entry into the parking area via the prepaid parking entrance is allowed.

18. The method of claim 17, further including the step of amending the prepaid ticket indicia data to show that the ticket indicia of the prepaid parking ticket has been used.

19. The method of claim 17, wherein the controllable entry indicator comprises a controllable gate.

20. The method of claim 17, wherein the controllable entry indicator comprises at least one light for indicating that entry into the parking area via the prepaid parking entrance is allowed and at least one light for indicating that entry into the parking area via the prepaid parking entrance is denied.

21. The method of claim 17, wherein the identification means comprises a bar code reader.

22. The method of claim 17, wherein the ticket indicia is a bar code element.

23. The method of claim 17, wherein the identification means comprises a means for reading inductively the ticket indicia stored in the prepaid parking ticket.

24. The method of claim 17, wherein the ticket indicia is included in an inductively readable memory integrated into the prepaid parking ticket.

25. The method of claim 17, wherein at least a portion of the prepaid parking ticket is adapted to be attached to an exteriorly visible surface of a user's vehicle.

26. The method of claim 17, wherein the ticket indicia on the prepaid parking ticket is identified while the user's vehicle is in movement past the identification means.

27. The method of claim 17, wherein at least a portion of the prepaid parking ticket comprises a sticker attachable to a surface of a vehicle.

28. The method of claim 17, wherein the identification means is located proximate to the controllable entry indicator.

29. The method of claim 17, wherein the identification means is a portable identification means.

30. A method of providing a prepaid parking ticket that permits prepaid access to a parking area, the method comprising the steps of:
providing a customer with an opportunity to purchase prepaid parking for at least one particular event;
providing, if the user purchases prepaid parking for the particular event, a prepaid parking ticket having a ticket indicia; and
including at least some data relating to the prepaid ticket indicia in a database, wherein at least some prepaid ticket indicia data is maintained regarding specific prepaid ticket indicia that has been included on provided prepaid tickets.

31. The method of claim 30, wherein the step of providing, if the user purchases prepaid parking for the particular event, a prepaid parking ticket having a ticket indicia includes the step of reactivating the ticket indicia of a previously provided prepaid parking ticket.

32. The method of claim 30, wherein the user is provided with the opportunity to purchase prepaid parking for the at least one particular event at a time when the user purchases a ticket to the at least one particular event.

33. The method of claim 30, wherein the ticket indicia is a bar code element.

34. The method of claim 30, wherein the ticket indicia is included in an inductively readable memory integrated into the prepaid parking ticket.

35. The method of claim 30, wherein at least a portion of the prepaid parking ticket is adapted to be attached to an exteriorly visible surface of a user's vehicle.

36. The method of claim 30, wherein at least a portion of the prepaid parking ticket comprises a sticker attachable to a surface of a vehicle.

37. An improved ticket, comprising:
an admittance portion for gaining entry to a particular event; and
a prepaid parking portion for gaining entry to a specific parking area for the particular event, wherein the prepaid parking portion includes a prepaid parking ticket indicia, that is identifiable by an identification means as a valid prepaid parking ticket indicia, such that, when the identification means identifies the prepaid parking ticket indicia as a valid prepaid parking ticket indicia, access is permitted to the specific parking area for the particular event.

38. The improved ticket of claim 37, wherein the prepaid ticket is a multi-part ticket wherein the admittance portion is separably attached to the prepaid parking portion.

39. The improved ticket of claim 37, wherein the ticket indicia is a bar code element.

40. The improved ticket of claim 37, wherein the ticket indicia can be reactivated.

41. The improved ticket of claim 37, wherein the ticket indicia is included in an inductively readable memory integrated into the prepaid parking ticket.

42. The improved ticket of claim 37, wherein at least a portion of the prepaid parking ticket is adapted to be attached to an exteriorly visible surface of a user's vehicle.

43. The improved ticket of claim 37, wherein at least a portion of the prepaid parking ticket comprises a decal attachable to a surface of a vehicle.

44. The improved ticket of claim 37, wherein the ticket indicia on the prepaid parking ticket can be identified while the user's vehicle is in movement past the identification means.
